(19) United States
(12) Patent Application Publication
(10) Pub. No.: US 2006/0234034 A1
(43) Pub. Date: Oct. 19, 2006

(54) Extrusion profile and method of production thereof

(76) Inventors: Thomas Tschech, MARBACH (DE); Helmut Schulte, Krefeld (DE); Georg Remmert, Leverkusen (DE)

Correspondence Address: Bayer Corporation;Patent Department, 100 Bayer Road, Pittsburgh, PA, 15205-9741, US

(21) Appl. No.: 10/489,289

(22) PCT Filed: Sep. 2, 2002
(86) PCT No.: PCT/EP02/09771

§ 371 Date: Sep. 17, 2004

(30) Foreign Application Priority Data
Sep. 13, 2001 (DE) 101 45 096.6

(51) Int. Cl. B32B 3/26; B32B 5/22

(52) U.S. Cl. 428/317.9; 428/304.4; 428/314.8

(57) ABSTRACT

An extrusion profile comprising a thermoplastic polymer is disclosed. The thermoplastic polymer, preferably polyamide, more preferably reinforced with glass fibers is characterized in that the polymer contains pores, having an average size of about 0.1 to 0.5 mm and that its density is at most 1 g/cm³. The profile is suitable as heat-insulating fastening web, in particular for the production of windows based on metal profiles.

This invention relates to an extrusion profile based on thermoplastic polymers, in particular polyamide, and a process for its production. The extrusion profile has gas pores, produced by a blowing agent, which bring about a decrease in the thermal conductivity of the profile.

The production of profiles by extrusion from glass-fibre reinforced polyamide is known. These profiles are used in particular as heat-insulating webs in the construction of windows. The heat-insulating webs are bonded to the two aluminium profiles of the window frame by adhesion and reduce the heat transfer and thereby prevent the formation of condensation on the warm side. The prefabricated polyamide-aluminium composite profiles are suitable for passage in enamelling furnaces at 220° C. to 230° C.

Aluminium windows are conventionally two-part constructions. The halves of the window frame are bonded to the heat-insulating webs by adhesion and, by reason of the low thermal conductivity of the profile, prevent the formation of condensation on the warm side. Moreover, the heat transfer of the overall construction is reduced by the use of the heat-insulating webs.

The object of the invention is to provide profiles based on thermoplastic polymers and a process for their production which avoids the disadvantages of the known profiles and results in a comparably lower thermal conductivity.

In addition, the profile is to have a certain elasticity. In the case of the known plastics materials, the pressing e.g. of aluminium profiles to the plastics profile in order to form a bond by adhesion may lead to a brittle rupture of the plastic.

Accordingly, elastic properties of the profile are also to be improved, if possible.

The object is achieved according to the invention by adding a gas-producing blowing agent to the polymeric composition of the type mentioned above in an extrusion process, prior to the extrusion.

The invention provides an extrusion profile based on thermoplastic polymers, in particular polyamide, particularly preferably polyamide 6.6, which in particular are reinforced with glass fibres and have a glass fibre content of 15 to 50 wt. %, particularly preferably of 20 to 30 wt. % glass fibres, characterised in that the density of the profile material is 1 g/cm³ at most and that the profile contains gas pores, having an average size of about 0.1 to 0.5 mm, distributed over the cross-section of the profile.

The glass fibres are preferably short glass fibres of 200 to 400 μm in length.

The density of the profile material is preferably 0.8 g/cm³ at most.

A particularly preferred embodiment of the extrusion profile is characterised in that the thermal conductivity of the profile, measured in the transverse direction, is 0.3 W/mK at most, in particular 0.25 W/mK at most, particularly preferably 0.2 W/mK at most.

Compared with the unfoamed profile, the extrusion profile exhibits a reduction in the thermal conductivity by at least 10%.

In order to facilitate a controlled foaming behaviour, the melting viscosity of the source polymer at the melting temperature (extrusion, for example, 290° C.) should be >2500 Pa·s at a shear rate of 50 sec⁻¹.

In principle, such heat-insulating webs can also be produced from PVC. However, the industrial production of finished window frame profiles, including stove enamelling at 220° C. to 230° C. in a continuous furnace, is not possible for PVC bonded to aluminium.

For further processing of the complete metal profile/extrusion profile composite, it is desirable that the extrusion profile has a heat deflection temperature of 220° C.

The coefficient of thermal expansion of the extrusion profile should be in particular within the range of 20 to 30 l/K, in order to keep subsequent stresses low.

Other types of polymer which are in principle suitable are polycarbonate, ABS, polypropylene, TPU or feasible mixtures of these polymers.

The invention also provides a process for producing extrusion profiles based on thermoplastic polymers, in particular polyamide, particularly preferably polyamide 6.6, which in particular are reinforced with glass fibres and have a glass fibre content of 15 to 50 wt. %, particularly preferably of 20 to 30 wt. % glass fibres, by melting the polymer and optionally additives, extruding the polymeric composition with the formation of a strand of profile, cooling and shaping the profile in a calibrator, drawing out and further cooling the profile in a cooling bath, characterised in that prior to the extrusion, a gas-producing blowing agent is added in a quantity of 0.1 to 5 wt. % to the polymer, the blowing agent decomposing at a temperature of above 180° C., and the polymeric composition is allowed to foam after having been discharged from the extrusion nozzle.

A process wherein the gas-producing blowing agent is added in a quantity of 0.5 to 2 wt. % is preferred.

The quality of the profiles can be ensured if, in a preferred process, the flow rate of the strand of polymer is measured and controlled prior to the calibrating step.

The flow rate is particularly preferably controlled through the withdrawal rate of the strand of profile.

The measurement is carried out particularly advantageously by means of an IR absorption sensor.

The invention also provides the use of the extrusion profiles according to the invention as heat-insulating fastening webs, in particular for the production of windows based on metal profiles, preferably aluminium profiles.

The invention is explained in more detail below with the aid of the Figures and by the Examples, which do not, however, constitute a limitation to the invention.

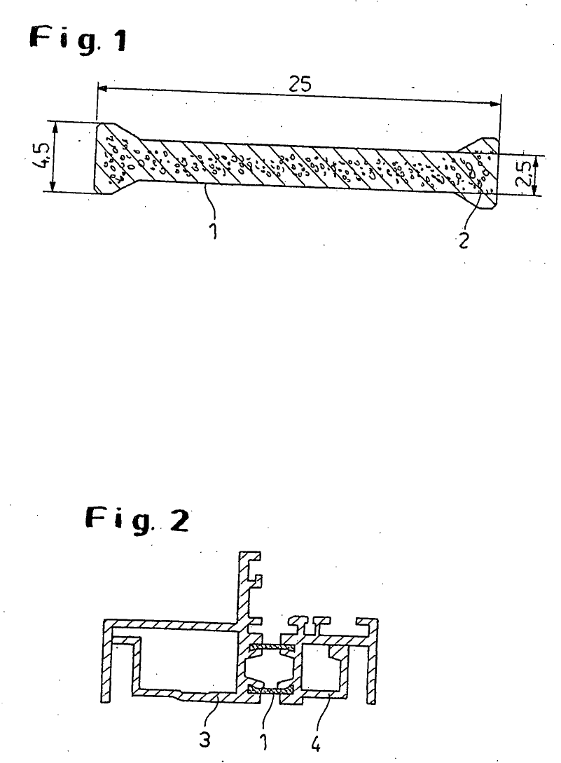

FIG. 1 shows a cross-section through an extrusion profile according to the invention.

FIG. 2 shows a cross-section through a heat-insulated aluminium profile and two window-insulating profiles.

### EXAMPLE

Extrusion Unit

The window-insulating profile was produced using conventional profile-extrusion technology. The unit consisted of an extruder, a calibrating and cooling line, a withdrawal unit and an automatic saw.

The extruder (manufacturer: Kuhne/Troisdorf) had a screw diameter of 48 mm and a screw length of 33 D (D=screw diameter). The screw was a three-zone screw without a degasser.

The calibrating bench, withdrawal unit and automatic saw used were products of Ide, Stuttgart.

Conventional corrosion- and temperature-resistant steels were used for the extrusion nozzle and calibrating unit. The surface of the calibrating unit with indirect cooling was highly polished.

The two calibrating shells could be tempered separately. The length of the calibrating line was approximately 115 mm. Subsequently the material was further cooled in a water bath.

The material was a polyamide of the type Durethan KU2-2240/25 H2.0 (manufacturer: Bayer AG) (PA 6.6 with a glass fibre content of 25 wt. %).

The polyamide was extruded at a temperature of 273° C. The processing conditions are listed in detail in Table 1. 2 wt. % of the blowing agent Hydrocerol HK 70 (blowing agent based on citric acid) had been added to the polyamide 6.6 in the feed zone. The polyamide was subjected to a preliminary drying under the following conditions:
Drying conditions
Temperature: 110° C.
Time:4 h
Drying equipment

Dry-air dryer from Gerco

TABLE 1
Processing conditions

| Temperature in ° C. | |
|---|---|
| Feed zone | 120 |
| Cylinder zone 1 | 290 |
| Cylinder zone 2 | 275 |
| Cylinder zone 3 | 255 |
| Cylinder zone 4 | 245 |
| Cylinder zone 5 | 245 |
| Flange | 245 |
| Nozzle | 255 |
| Rate of rotation in min⁻¹ | 10 |
| Pressure on material, in bar | 10 |
| Melting temperature in ° C. | 273 |
| Withdrawal rate in m/min | 1.5 |
| Throughput in kg/h | 5.3 |

The following properties of the finished profile were measured:

| | | |
|---|---|---|
| Density: | 0.70 g/cm³ | (1.24 g/cm³ unfoamed profile) |
| Thermal conductivity: | 0.26 W/mK | (0.35 W/mK unfoamed profile) |

The values for an unfoamed profile are shown in brackets.

The superiority of the foamed profile over a prior art profile is obvious here.

FIG. 1 shows a diagram of profile 1 in cross-section. Here the pores 2 of gas are distributed over the entire cross-section. Two profiles 1 produced by the above process were mounted in an aluminium window frame (see FIG. 2) between the sections of the frame 3 and 4 and fixed by pressing the aluminium guide. In use, there is a decreased heat transfer between the sections of the frame 3 and 4.

1. Extrusion profile based on thermoplastic polymers, in particular polyamide, particularly preferably polyamide 6.6, which in particular are reinforced with glass fibres and have a glass fibre content of 15 to 50 wt. %, particularly preferably of 20 to 30 wt. % glass fibres, characterised in that the density of the profile material is 1 g/cm³ at most and that the profile contains pores, having an average size of about 0.1 to 0.5 mm, distributed over the cross-section of the profile.

2. Extrusion profile according to claim 1, characterised in that the glass fibres are short glass fibres of 200 to 400 μm in length.

3. Extrusion profile according to claim 1, characterised in that the density of the profile material is 1 g/Cm³ at most, preferably 0.9 g/cm³ at most, particularly preferably 0.8 g/cm³ at most.

4. Extrusion profile according to claim 1, characterised in that the thermal conductivity of the profile, measured in the transverse direction, is 0.3 W/mK at most, in particular 0.25 W/mK at most, particularly preferably 0.2 W/mK at most.

5. Extrusion profile according to claim 1, characterised in that the melting viscosity of the source polymer at 290° C. and at a shear rate of 50 sec⁻¹ is greater than 2500 Pa·s.

6. Process for producing extrusion profiles, in particular according to claim 1, based on thermoplastic polymers, in particular polyamide, particularly preferably polyamide 6.6, which in particular are reinforced with glass fibres and have a glass fibre content of 15 to 50 wt. %, particularly preferably of 20 to 30 wt. % glass fibres, by melting the polymer PO8131 and optionally additives, extruding the polymeric composition with the formation of a strand of profile, cooling and shaping the profile in a calibrator, drawing out and further cooling the profile in a cooling bath, characterised in that prior to the extrusion, a gas-producing blowing agent is added in a quantity of 0.1 to 5 wt. % to the polymer, the blowing agent decomposing at a temperature of above 180° C., and the polymeric composition is allowed to foam after it has been extruded.

7. Process according to claim 6, characterised in that the gas-producing blowing agent is added in a quantity of 0.5 to 2 wt. %.

8. Process according to claim 6, characterised in that the flow rate of the strand of polymer is measured and controlled prior to the calibrating step.

9. Process according to claim 8, characterised in that flow rate is controlled through the withdrawal rate of the strand of profile.

10. Process according to claim 8, characterised in that the measurement is carried out by means of an IR absorption sensor.

11. Process according to claim 6, characterised in that the melting viscosity of the polymer used at 290° C. is more than 2500 Pa·s at a shear rate of 50 sec⁻¹.

12. (canceled)

13. A heat-insulating fastening web comprising the extrusion profile of claim 1.
